(19) United States
(12) Patent Application Publication
(10) Pub. No.: US 2018/0066455 A1
(43) Pub. Date: Mar. 8, 2018

(54) Combination Lock

(71) Applicant: Ming-Hsun Tsai, Tainan City (TW)

(72) Inventor: Ming-Hsun Tsai, Tainan City (TW)

(21) Appl. No.: 15/343,002

(22) Filed: Nov. 3, 2016

(30) Foreign Application Priority Data
Sep. 5, 2016 (TW) 105128573

(51) Int. Cl. E05B 71/00; E05B 37/02

(52) U.S. Cl. CPC E05B 71/00; E05B 37/02

(57) ABSTRACT

Disclosed is a combination lock comprising a housing member, a locking bar, a pushing element and a password entering element, wherein the housing member includes two insertion holes, two locking elements, and a linkage element, the two locking elements are disposed extending to the two insertion holes, the linkage element is connected between the two locking elements, and two end portions of the locking bar are removal inserted into the two insertion holes.

### FIELD OF THE INVENTION

The present invention relates to an anti-theft lock, and more particularly relates to a combination lock.

### BACKGROUND OF THE INVENTION

An anti-theft lock is generally used in a bicycle or a motorcycle to prevent the bicycle or the motorcycle from being stolen. A combination lock is a kind of popular anti-theft locks since it is with advantage of not using key. A conventional combination lock includes a main body and a shackle whose two ends are inserted into two holes of the main body.

However, in spite that the two ends of the shackle are inserted into the two holes of the main body in the conventional combination lock, there is only one hole provided with a locking mechanism but another hole is only buckled to the corresponding end of the shackle. In other words, the conventional combination lock only provides the locking function in one hole of the main body, but not the two holes of the main body. Therefore, when the end of the shackle, which is locked, is applied by an external force, it is easy to be destroyed. In addition, the conventional combination lock has another drawback that each end of the shackle is limited to be inserted into specific one of the holes of the main body. The inserting manner is thus restricted in the conventional combination lock. Therefore, the conventional combination lock has insufficient anti-theft function and needs to be improved.

### SUMMARY OF THE INVENTION

Accordingly, one object of the present invention is to provide a combination lock having enhanced locking stability between the shackle and the main body to prevent the combination lock from being unexpectedly unlocked.

In order to overcome the technical problems of the prior art, the present invention provides a combination lock comprising: a housing member including two insertion holes, two locking elements, and a linkage element, wherein the two insertion holes respectively corresponding to the two locking elements are respectively recessed from an upper surface of the housing member toward inside of the housing member, the two locking elements are disposed in the housing member by extending each locking element from the inside of the housing member toward the two insertion holes in such a manner that one end of each locking element is exposed within the insertion hole to which the locking element corresponds, and the linkage element is provided connecting between the two locking elements in a manner that the two locking elements are allowed to move only in one same direction; a locking bar whose two end portions are provided with two recesses by which each recess is in a position corresponding to one insertion hole and is removal locked by the locking elements when the two end portions of the locking bar are removal inserted into the two insertion holes; a pushing element, disposed in the housing member, pressing against at least one locking element; and a password entering element, disposed in the housing member and connected to the linkage element, provided to switch between a locking state and an unlocking state, wherein in the locking state, the linkage element is locked by the password entering element to block a movement of two locking elements such that the two locking elements are kept locked in the two insertion holes as being locked by the two recesses, and in the unlocking state, since the movement of the linkage element is released by the password entering element, the pushing element is pushed to move one locking element to move the linkage element so as to move another locking element such that the two locking elements are disengaged with the two insertion holes to release the lock.

In the combination lock according to one embodiment of the present invention, the password entering element is positioned between the two insertion holes.

In the combination lock according to one embodiment of the present invention, the pushing element is formed on one end of the housing member.

In the combination lock according to one embodiment of the present invention, the locking bar is U shaped.

In the combination lock according to one embodiment of the present invention, the two recesses of locking bar are located at the same height level.

In the combination lock according to one embodiment of the present invention, the linkage element includes a linkage element and a spring, the linkage element is located between the two locking elements, and the spring directly or indirectly presses against the linkage element to push the two locking elements in such a manner that one end of each locking element is exposed within the insertion hole.

In the combination lock according to one embodiment of the present invention, at least one of the locking elements is formed as an arcuate portion extending upwardly from an upper surface of the linkage element.

In the combination lock according to one embodiment of the present invention, the password entering element is provided fitting around the linkage element and is rotatable on a rotation axis of the linkage element.

By the technical means adopted by the present invention, when the combination lock is in the locking state, the two locking elements of the housing member are securely fastened with the two recesses of the locking bar so that the locking stability between the locking bar and the housing member is improved to prevent the combination lock from being unexpectedly unlocked by external forces, thereby maintaining the anti-theft function of the combination lock. Furthermore, the two recesses are provided on the locking bar such that the locking bar can be removed from the housing member and can be inserted into the housing member in any direction to thus increase the convenience of using the combination lock.

### BRIEF DESCRIPTION OF THE DRAWINGS

FIG. 1 is a schematic stereogram illustrating a combination lock according to one embodiment of the present invention;

FIG. 2 is a schematic drawing illustrating the combination lock when in a locking state according to the embodiment of the present invention; and

FIG. 3 is a schematic drawing illustrating the combination lock when in an unlocking state according to the embodiment of the present invention.

### DETAILED DESCRIPTION OF THE PREFERRED EMBODIMENTS

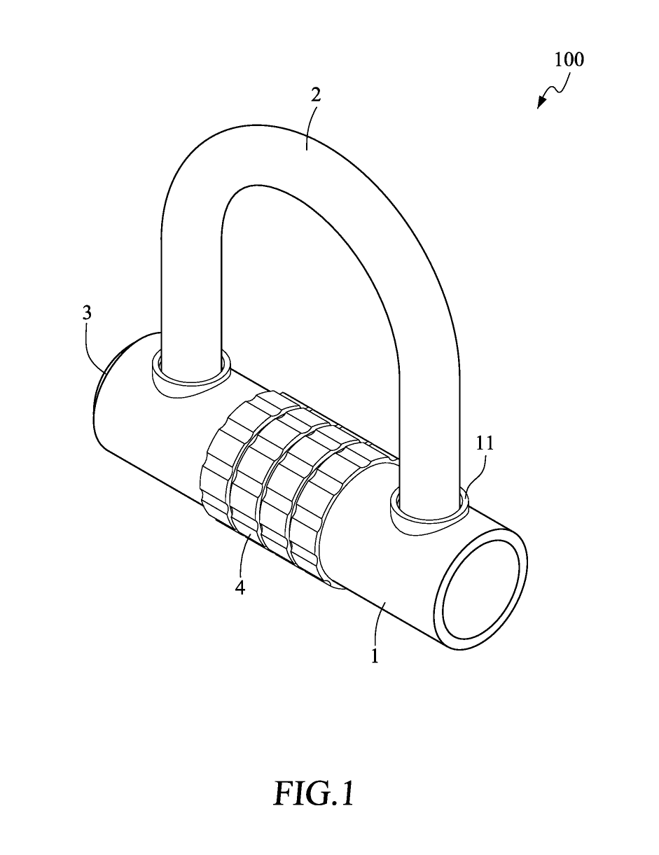

The preferred embodiments of the present invention are described in detail below with reference to FIG. 1 to FIG. 3. The description is used for explaining the embodiments of the present invention only, but not for limiting the scope of the claims.

As shown in FIG. 1, a combination lock 100 according to one embodiment of the present invention includes a housing member 1, a locking bar 2, a pushing element 3 and a password entering element 4.

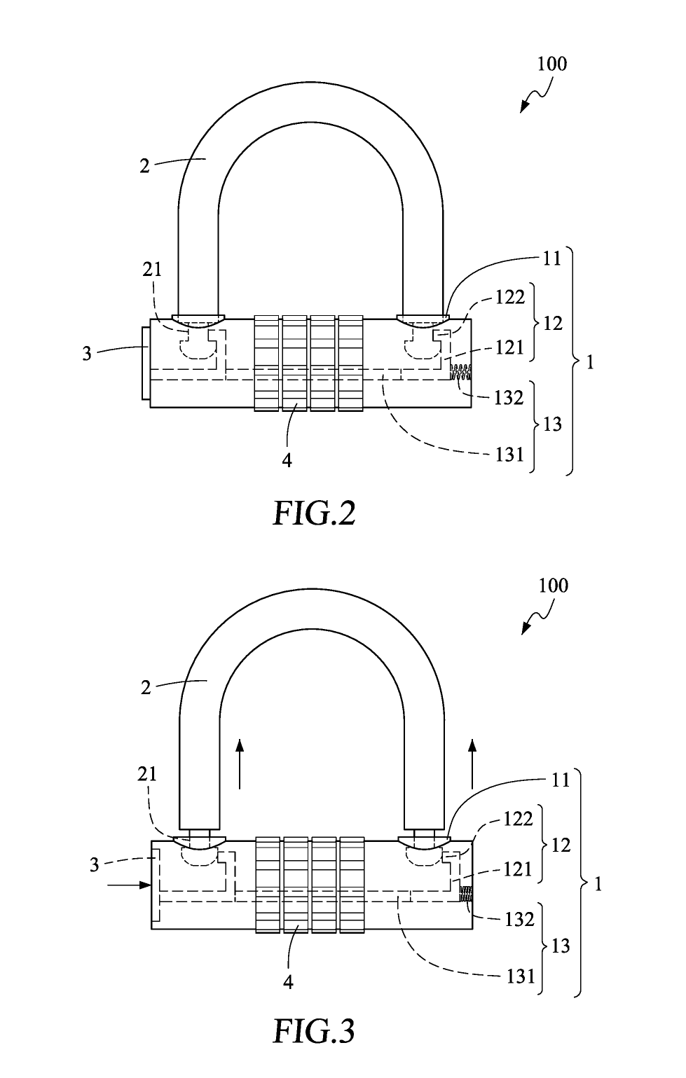

As shown in FIG. 2, the housing member 1 includes two insertion holes 11, two locking elements 12 and a linkage element 13. The two insertion holes 11 are respectively recessed from an upper surface of the housing member 1 toward inside of the housing member 1. The two locking elements 12 are provided extending from the inside of the housing member 1 to the two insertion holes 11. In the embodiment, at least one of the locking elements 12 is formed as an arcuate portion extending upwardly from an upper surface of the linkage element 13.

The linkage element 13 includes a connecting rod 131 and a biasing element 132. The connecting rod 131 is connected between the two locking elements 12 in a manner that the two locking elements 12 are allowed to move only in one same direction. In the embodiment, the biasing element 132 is provided pressing against the connecting rod 131 in a direct manner to bias the two locking elements 12 toward the two insertion holes 11. However, the present invention is not limited to this, and the biasing element 132 may be provided pressing against the connecting rod 131 in an indirect manner. For example, the biasing element 132 is a spring elastically biased against the connecting rod 131.

As shown in FIG. 1 and FIG. 2, in the embodiment, the locking bar 2 is U shaped and is bilaterally symmetrical. The locking bar 2 has two end portions each corresponding to one insertion hole 11, and the two end portions of the locking bar 2 are removably inserted into the two insertion holes 11. Specifically, the two end portions of the locking bar 2 are formed with two recesses 21 each of which being in a position corresponding to one locking element 12 for removably fastening with the locking element 12. In the embodiment, the two recesses are respectively an annular groove and can be fastened with either of the locking elements 12. However, the present invention is not limited to this. The locking bar 2 may be provided at each end portion with two recesses 21, each of which is positioned at a radial surface of the end portion such that each end portion of the locking bar 2 can be fastened with either of the locking elements 12.

As shown in FIG. 1 and FIG. 2, the pushing element 3 is disposed at one side of the housing member 1 and presses against at least one locking element 12. In the embodiment, the pushing element 3 is disposed pressing against the adjacent one of the locking elements 12.

As shown in FIG. 2 and FIG. 3, the password entering element 4 is provided fitting around the linkage element 13 and is rotatable on a rotation axis of the linkage element 13. The password entering element 4 is provided to switch between a locking state (FIG. 2) and an unlocking state (FIG. 3).

As shown in FIG. 2, in the locking state, the linkage element 13 is locked by the password entering element 4 to block a movement of two locking elements 12 such that the two locking elements 12 are kept locking in the two insertion holes 11 and being locked by the two recesses.

As shown in FIG. 3, in the unlocking state, since the movement of the linkage element 13 is released by the password entering element 4, the pushing element 3 is pushed to move one locking element 12 to move the linkage element 13 so as to move another locking element 12 such that the two locking elements 12 are disengaged from the two insertion holes 11 to release the lock.

The above description is only an explanation of the preferred embodiments of the present invention. A person with ordinary skill in the art can make various modifications without deviating from the present invention. However, those modifications shall still fall within the scope of the present invention.

1. A combination lock comprising:
a housing member including two insertion holes, two locking elements and a linkage element, wherein the two insertion holes respectively corresponding to the two locking elements are respectively recessed in a radial direction of the housing member from an upper surface of the housing member toward inside core of the housing member, and the two locking elements are disposed in housing member by extending each locking element in a radial direction of the housing member from the inside core of the housing member to connect the two insertion holes in such a manner that one end of each locking element is exposed within the insertion hole to which the locking element corresponds, and the linkage element is provided extending in an axial direction of the housing member to connect the two locking elements in a manner that the two locking elements move together with the linkage element in the axial direction of the housing member;
a locking bar whose two end portions are provided with two recesses by which each recess is in a position corresponding to one insertion hole and is removal locked by the locking elements when the two end portions of the locking bar are removal inserted into the two insertion holes;
a pushing element, disposed in the housing member, pressing against at least one locking element; and
a password entering element, disposed in the housing member and connected to the linkage element, provided to switch between a locking state and an unlocking state,
wherein the two locking elements respectively have an extending portion and a hook portion, and each extending portion extends in the radial direction of the housing member from a radial upper surface of the linkage element, each hook portion extends in the axial direction from an end of the extending portion to connect the corresponding insertion hole, and the hook portion is provided to be inserted to the recess in the locking state,
wherein
in the locking state, the linkage element is locked by the password entering element to block a movement of two locking elements in the axial direction of the housing member such that the two hook portions are kept inserted in the two insertion holes so as to be locked by the two recesses, and
in the unlocking state, since the movement of the linkage element is released by the password entering element, the pushing element is pushed to move one locking element to move the linkage element so as to move another locking element such that the two hook portions are disengaged with the two insertion holes to release the lock.

2. The combination lock as claimed in claim 1, wherein the password entering element is positioned between the two insertion holes.

3. The combination lock as claimed in claim 1, wherein the pushing element is disposed at one end of the housing member.

4. The combination lock as claimed in claim 1, wherein the locking bar is U shaped.

5. The combination lock as claimed in claim 1, wherein the two recesses of locking bar are located at the same height level.

6. The combination lock as claimed in claim 1, wherein the linkage element includes a connecting rod and a biasing element, the connecting rod is located between the two locking elements, and the biasing element directly or indirectly presses against the connecting rod to push the two locking elements in such a manner that one end of each locking element is exposed within the insertion hole.

7. (canceled)

8. The combination lock as claimed in claim 1, wherein the password entering element is provided fitting around the linkage element and is rotatable on a rotation axis of the linkage element.
